(19) United States
(12) Patent Application Publication
(10) Pub. No.: US 2004/0148361 A1
(43) Pub. Date: Jul. 29, 2004

(54) System and method for migrating directories over a wide-area network

(76) Inventor: Jay W. Ridgley, Round Rock, TX (US)

Correspondence Address: B. Noel Kivlin, Meyertons, Hood, Kivlin, Kowert & Goetzel, P.C., P.O. Box 398, Austin, TX, 78767, US

(21) Appl. No.: 10/352,303

(22) Filed: Jan. 27, 2003

(51) Int. Cl. G06F 15/167

(52) U.S. Cl. 709/212

(57) ABSTRACT

A system and method for migrating a directory across a network. In one embodiment a computer network implements a method comprising accessing a stored directory in a first domain of a computer network, copying the directory to a second domain of said computer network, creating an indication that the directory has been copied to the second domain and accessing the directory on the second domain. The method may be triggered by a user locally logging on to the second domain. The method may also occur in response to a request for directory migration provided by a user. In further embodiments, the directory may migrate to additional domains, and may ultimately migrate back to the first domain.

### BACKGROUND OF THE INVENTION

1. Field of the Invention

This invention relates to the field of network computer systems and, more particularly, to a method for migrating computer directories across a networked computer system.

2. Description of the Related Art

Computer networks are an integral part of many modem computer systems, allowing data to be transferred between multiple locations and accessed by large numbers of people. Computer networks may comprise multiple nodes connected by some form of interconnect; a node may be a PC, workstation, laptop, PDA, or other terminal device, while possible interconnects may be Ethernet, wireless, optical or some other form of connection.

Networks are commonly owned and used by a single organization, which may limit the size of the network to a single floor, building or campus. Alternatively the network may be large enough to span several cities or countries. Depending on the size of the network, the network may be further divided into domains, which are partitions of the network that may be divided by local topology or internal divisions within the organization.

Within many networks, each user within the network commonly has their own account, which includes one or more directories containing work-related and/or personal files. Depending on the structure and type of the network, files and directories may reside on individual nodes and be shared between nodes as needed. Alternatively, files and directories in a network domain may exist within a common file system using a protocol such as the Network File System (NFS).

Commonly, a user of a computer network may access any node within the user's home domain. If the nodes in such a domain run the NFS protocol, then logging in to any node within the user's home domain will provide the user with immediate, local access to the data files within the user's home directory.

Alternatively, the user may travel to a remote domain in the network. If the user logs on to one of the nodes in a remote domain, the user's home directory will not be locally accessible to the node that he or she is on. Traditionally, the user may then remotely access their home directory through a remote connection, such as a telnet or secure shell (ssh) session. If the computer network has sufficient bandwidth, the user may alternatively access their home directory via a mechanism such as X-Windows, which replicates all aspects of a graphical user interface (GUI) session on a remote node.

However, severe network latency may prevent even text-based connections such as telnet or ssh from being effective. Especially on large wide-area networks, the user's interaction with their home node may be so slow as to make a remote connection useless.

The user may alternatively copy their directory one file at a time or en masse with a tool such as FTP, although such a method places the burden of maintaining data coherency on the user. This may lead to the user having multiple versions of a home directory on multiple nodes scattered throughout a computer network, with no easy way to determine which version of a file is current or even where the current version of a file is.

### SUMMARY OF THE INVENTION

A system and method for migrating a directory across a network is disclosed. In one embodiment a computer network implements a method comprising accessing a stored directory in a first domain of a computer network, copying the directory to a second domain of said computer network, creating an indication that the directory has been copied to the second domain and accessing the directory on the second domain. The directory migration may be triggered in response to detecting that a user has locally logged on to the second domain. The directory migration may alternatively be triggered in response to a request provided by a user. In further embodiments, the directory may migrate to additional domains, and may ultimately migrate back to the first domain in accordance with corresponding actions by the user.

### BRIEF DESCRIPTION OF THE DRAWINGS

FIG. 1 is a block diagram of one embodiment of a computer network 100.

FIG. 2 is a block diagram that illustrates an embodiment of a processing node.

FIG. 3 is tree diagram illustrating an exemplary file system.

FIG. 4 is a flow diagram depicting operations associated with one embodiment of a directory migration.

FIG. 5 is flow diagram illustrating one embodiment of a migration from a home domain to a remote domain.

FIG. 6 is flow diagram illustrating one embodiment of a migration from one remote domain to another domain.

FIG. 7 is flow diagram illustrating one embodiment of a migration from a remote domain to a home domain.

FIG. 8 is a flow diagram depicting operations associated with an alternate embodiment of a directory migration.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION

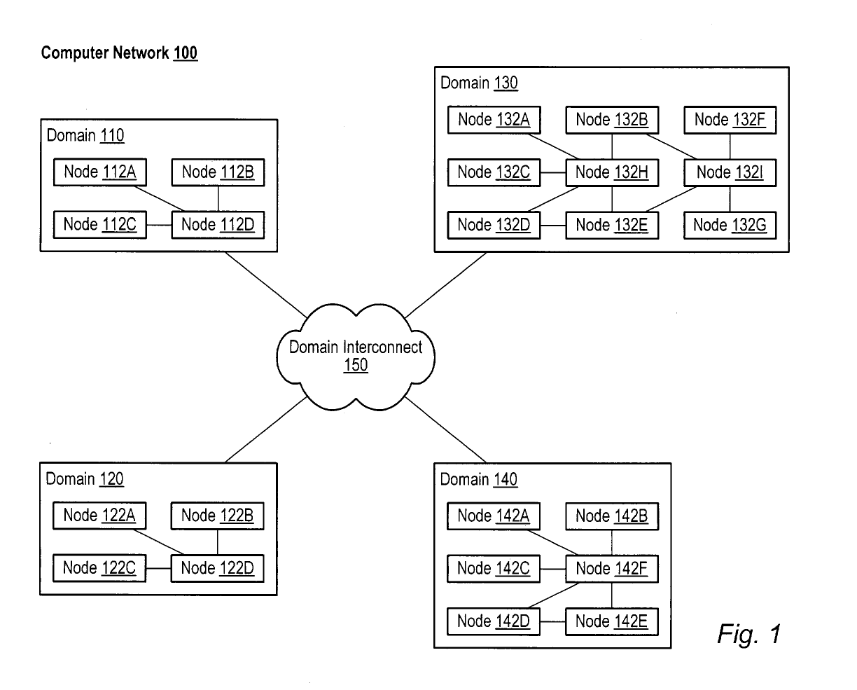

Turning now to FIG. 1, a block diagram of one embodiment of a computer network 100 is shown. Computer network 100 contains multiple network domains, 110, 120, 130, and 140, each including a plurality of nodes which may be connected together in a variety of ways. For example, domain 110 includes nodes 112A-D, while domain 130 includes of nodes 132A-I. It is noted that the number of domains is purely illustrative, and that a network may include any number of domains. Likewise, the number of nodes within a domain may vary from one to one thousand or more. Depending on the size of the network 100, a domain interconnect 150 may be a router, a set dedicated network lines, or a virtual private network (VPN) running over the Internet. In the case of a wide area network (WAN) or VPN, the domains within a network may be local area networks (LANs) in their own right.

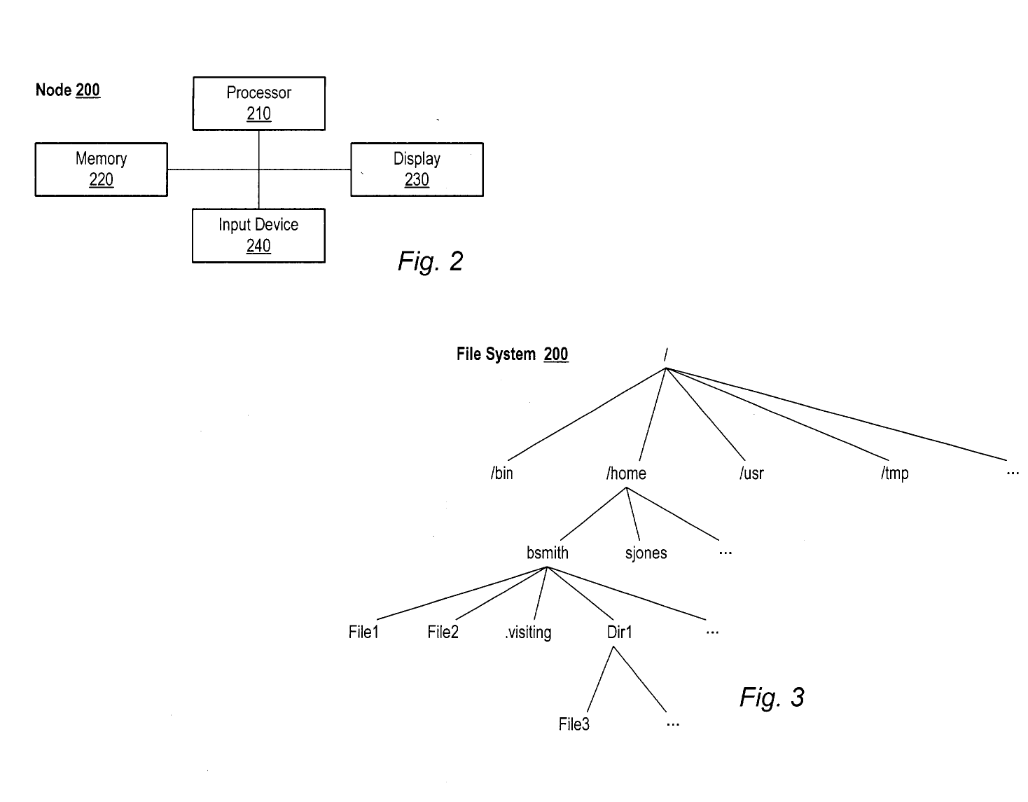

FIG. 2 illustrates an exemplary node 200, which is illustrative of any of the nodes of FIG. 1. Node 200 includes a processor 210, a memory 220, a display 230, and some form of input device 240 such as a keyboard or a mouse. Such a node may be a laptop, desktop, server, workstation, terminal, personal digital assistant (PDA) or other type of system.

FIG. 3 illustrates an exemplary file system 300 found on one or more nodes in computer network 100. The file system includes a root directory (“/”), which contains numerous subdirectories, each of which contains additional subdirectories as well as one or more files. Each subdirectory within file system may also be referred to as a directory in its own right. Although a file system 300 may reside within the memory 220 of a node or server, it is also common for multiple nodes within a domain to share a common file system via the network file system (NFS) protocol. In such a protocol, the file system would reside on one or more servers within the domain. Alternatively, individual files and directories may be shared between nodes within a domain in a peer-to-peer configuration.

The specific file system in FIG. 3 is exemplary of a UNIX or Linux file system, wherein each user of the system is allowed their own personalized home directory (“bsmith”, “sjones”, etc.) Such directories traditionally exist within the “/home” directory, and typically contain files relevant to each user's work on the system. Included in the exemplary “bsmith” home directory as illustrated in FIG. 3 is a .visiting file, the use of which will be described below.

Computer network 100 is configured such that as a user moves between network domains, the user's home directory also migrates between those same network domains. In one possible implementation, when a user logs on to a remote domain, a copy of their home directory is automatically sent to that same remote domain in accordance with software executing in the network. In various embodiments, as the user moves to additional domains, the copy of their home directory is also transferred to such domains. Further details regarding these directory migration operations are provided below.

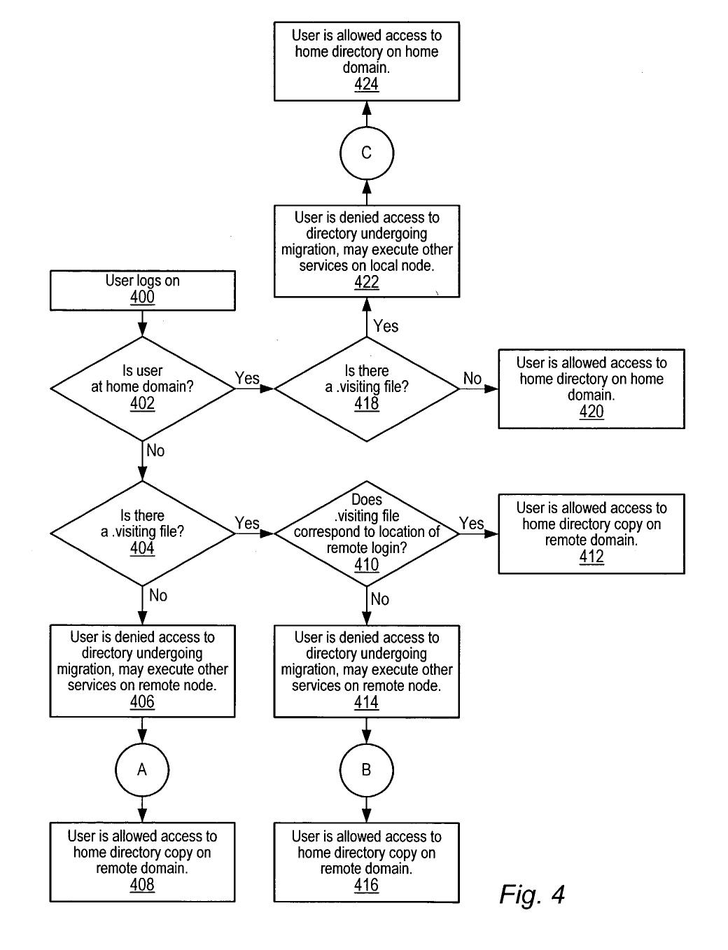

FIG. 4 is a flow diagram illustrating one embodiment of a method for migrating a directory across a network. In step 400 the user logs on to a node on the computer network. In step 402 the node begins to execute a sequence of instructions, first determining if the user is logging on from their home domain. If the user is not logging on from the user's home domain, the node may then proceed to step 404.

In step 404 the node attempts to locate a .visiting file within the user's home directory. The presence of a .visting file indicates that the home directory has been transferred to a remote domain, as will be further described below. If the node fails to find a .visiting file within the home directory, the method may then move to step 406, in which the user is allowed access to files and services on the user's current remote domain. However, the user may be blocked from accessing their home directory on their home domain to ensure coherence between directory copies.

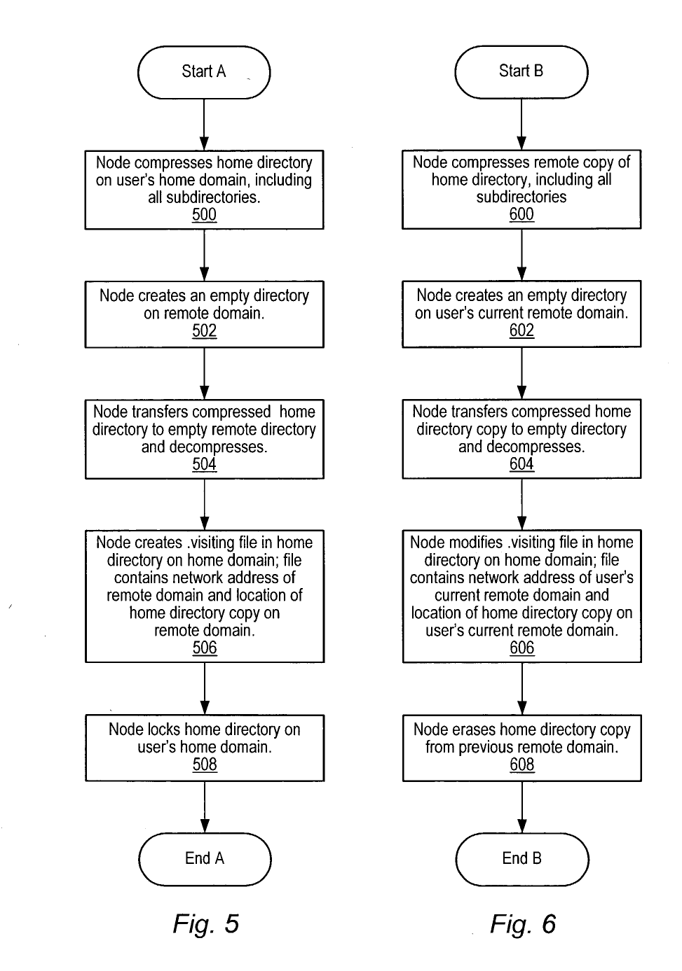

The node then proceeds to execute steps 500-508, as depicted in FIG. 5. This sequence of operations depicts an embodiment of the directory migration process wherein which the user's home directory is moved from the user's home domain to the user's current remote domain. In step 500 the node accesses the user's home domain via a remote connection. The node then creates a compressed archive of the user's home directory and all subdirectories. In step 502 the node creates an empty directory on the user's current remote domain.

In step 504 the node copies the compressed archive from the user's home domain to the user's current remote domain. The node may then uncompress and install the archive onto the empty directory on the user's current remote domain.

In step 506 the node creates a .visiting file in the home directory stored on the user's home domain. In one embodiment, the .visiting file is a text file which contains information such as the network address of the user's current remote domain and the location of the copied directory on the user's current remote domain. It is noted that in other embodiments, the .visiting file may be a binary system file in a proprietary format. In still other embodiments, a .visiting file may not exist, and the information that would otherwise be contained in the .visiting file as described herein may instead be stored in other locations, such as a user's system profile.

Lastly, in step 508 the node may lock the user's home directory on the user's home domain. This prevents access to and modification of the data therein while another copy of the user's home directory is outstanding. This step completes the directory migration. The method then returns to step 408 as illustrated in FIG. 4, in which the user is allowed to access their copied home directory, which now resides on the user's current remote domain.

Returning to step 404, a .visiting file may already exist in the home directory, which may cause the node to advance to step 410. If the .visiting file contains the name of the user's current remote domain, this indicates that the user's home directory has already migrated to the user's current remote domain. No further action is therefore needed and the user may access their copied home directory on their current remote domain in step 412.

Alternatively, the .visiting file may list the name of another remote domain, one that is neither the user's home domain nor the user's current remote domain. In this case, the node moves to step 414, which is similar to step 406 in that the user is allowed access to files and services on user's current remote domain, but may be blocked from accessing all outstanding copies of their home directory.

The node then proceeds to execute steps 600-608, as depicted in FIG. 6. This sequence of operations depicts an embodiment of the directory migration process wherein the user's home directory is moved from the user's previous remote domain to the user's current remote domain. In step 600 the node accesses user's previous remote domain via a remote connection. The node then creates a compressed archive of the previous remote domain's copy of the home directory. In step 602 the node creates an empty directory on the user's current remote domain.

In step 604 the node copies the compressed archive from the user's previous remote domain to the user's current remote domain. The node may then uncompress and install the archive into the empty directory.

In step 606 the node modifies the .visiting file on the user's home domain. The network address of the user's current remote domain and the location of the copied directory on the user's current remote directory are entered into the .visting file, overwriting the previous values. The node then proceeds to step 608, wherein the copy of the user's home directory is deleted from the user's previous remote domain. This completes the directory migration. The method then returns to step 416 as illustrated in FIG. 4, in which the user is allowed to access their copied home directory on the user's current remote domain.

Returning to step 402, the user may be logging on to their home domain, rather than a remote domain. The node would then move to step 418, in the node would search for a .visiting file. If a .visiting file does not exist, there is no outstanding copy of the home directory and the user may access their home directory on their home domain in step 420.

Alternatively, a .visiting file may exist in the home directory, indicating an outstanding copy of the home directory on a remote domain. The node then advances to step 422, in which the user is allowed access to files and services on their home domain, but not to their home directory while directory migration occurs.

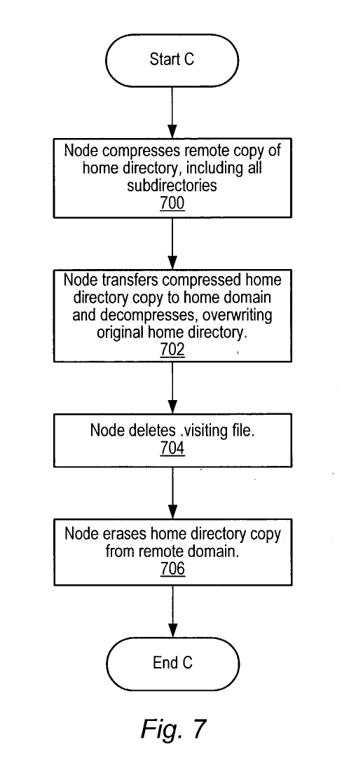

The node then proceeds to execute steps 700-706, as depicted in FIG. 7. This sequence of operations depicts an embodiment of the directory migration process wherein the user's home directory is move from the user's home domain to the user's current remote domain. In step 700 the node accesses the remote directory via a remote connection. The node then creates a compressed archive of the copy of the user's home directory.

In step 702 the node copies the compressed archive from the remote domain to the user's home domain. The node may then uncompress and install the archive over the user's previous home directory.

In step 704 the node deletes the .visiting file from the user's home directory on the user's home domain. Lastly, in step 706, the node deletes the previous copy of the user's home directory from the remote domain. The method then returns to step 424 as illustrated in FIG. 4, in which the user is allowed to access their copied home directory, which now resides on the node's local domain.

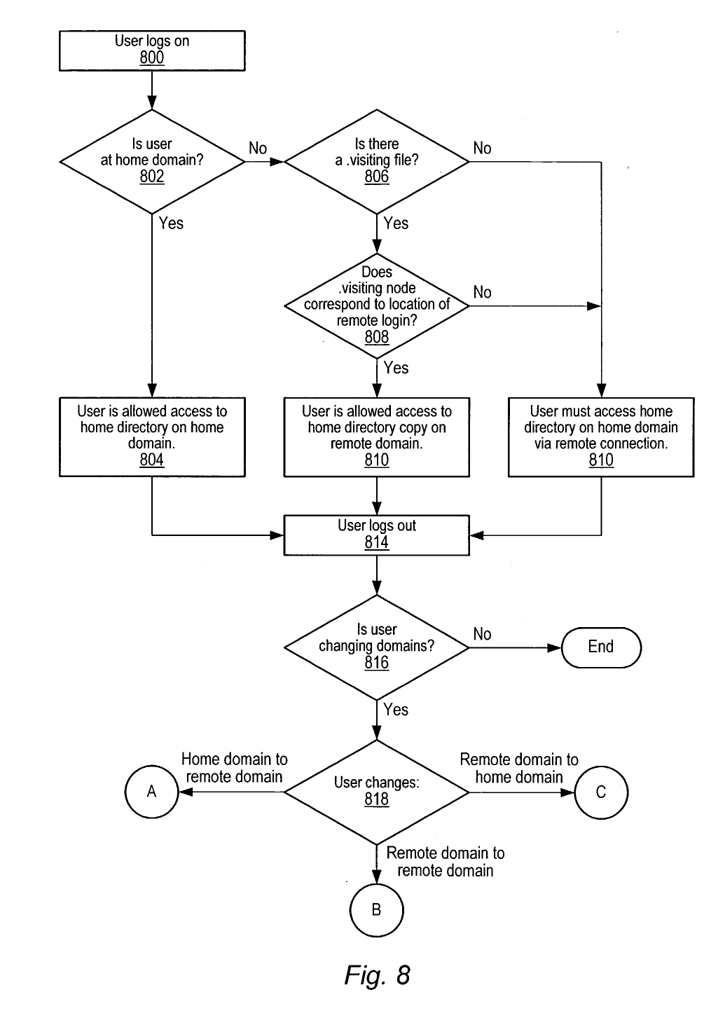

FIG. 8 illustrates aspects of an alternative embodiment of directory migration, wherein the user's movement from one network domain to another is indicated by the user ahead of time. By migrating the home directory from domain to domain while the user is logged off of the network, the home directory may be made immediately available to the user when the user next logs in at a new domain.

In step 800, the user logs on to the computer network at a specific node. The node then begins to execute a series of instructions, first determining if the user has logged on to their home domain in step 802. If the user is at their home domain, the user is then allowed to access their home directory on the local domain in step 804.

Alternatively, if the user is logging on from a remote domain, the node executes step 806, wherein it determines if a .visiting file exists within the user's home directory. If a .visiting file exists, the node moves to step 808, wherein the node determines if the remote domain indicated in the .visiting file is the same domain the user is currently logging in from. If so, the node advances to step 810 wherein the user is granted access to the copy of their home directory on the remote domain.

If the node detects that the user is not logging on from the same remote domain as listed in the .visiting file in step 808, the node then advances to step 812. Step 812 may also be reached from step 806, if the node finds no .visiting file within the user's home directory. In step 812, the user must access their home directory through a remote connection, since no directory migration has occurred. It is noted that not migrating the directory between domains in this embodiment may be advantageous in situations where the duration of the user's stay in a remote domain is very brief, or when the network latency between remote domains is low.

Steps 804, 810 and 812 all end with the user logging off their current domain in step 814. In step 816 the node determines if the user intends to move from one domain to another. This indication may be invoked in response to actions taken by the user prior to logging off or from an indication that the user makes during the log off process. If the user does not intend to move to another domain, the method ends.

In step 818, depending on the user's movements, the node executes an appropriate set of instructions to migrate the user's directory from one domain to another. If the user is moving from the user's home domain to a remote domain, the node executes steps 500-508, as illustrated in FIG. 5 and described above. If the user is moving from one remote domain to another remote domain, steps 600-608, described in FIG. 6, are triggered. Lastly, if the user is returning from a remote domain to their home domain, steps 700-706, illustrated in FIG. 7, are executed. Thus, as a result of these operations, the user's home directory (or a copy thereof) will be located on the user's current domain when the user next logs in.

In accordance with the foregoing description, as a user moves between network domains, the user's home directory also migrates between network domains in order to follow the user. Because the user and the user's home directory maintain proximity to each other within the network, the user experiences less delay in accessing their data. The user is thus able to work more efficiently while logging on through a remote domain.

It is contemplated that in other embodiments, other directories or files may be migrated across the network in response to a user's remote logon. These directories and files may be in addition to or in place of the user's home directory in the migration.

Furthermore, it is noted that in other embodiments, the directory migration may be triggered in response to activities other than the user logging on to a domain or an indication that the user will be moving to a new domain. For example, in one possible embodiment, the network may detect a change in the user's location through the user's cell phone, laptop, PDA or other device. In such embodiments, when a change in the user's location is detected via a wireless locator system such as GPS, a directory may be migrated to a network domain local to the user's new location. Alternatively, the network may cause directory migration to occur in accordance with a schedule of the user's movements, such as a schedule associated with the user's appointment calendar.

In yet another embodiment, the directory migration may occur across the Internet between peer nodes. In addition, depending on the structure and types of nodes within the network, the migration may be carried out by another node within the network or local domain, such as a local server, rather than by the node that the user has logged on to.

It is further noted that, rather than logging on to a preexisting node within the local domain, the user may access the local domain by connecting a portable node, such as a laptop or PDA, to the local domain. In such a scenario, a detection of a connection of the user's portable node to the local domain may be used to trigger directory migration.

Various embodiments may further include receiving, sending or storing instructions and/or data that implement the operations described above in conjunction with FIGS. 4-8 upon a computer readable medium. Generally speaking, a computer readable medium may include storage media or memory media such as magnetic or optical media, e.g. disk or CD-ROM, volatile or non-volatile media such as RAM (e.g. SDRAM, DDR SDRAM, RDRAM, SRAM, etc.), ROM, etc. as well as transmission media or signals such as electrical, electromagnetic, or digital signals conveyed via a communication medium such as network and/or a wireless link.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
accessing a stored directory in a first domain of a computer network;
copying the directory to a second domain of said computer network;
creating an indication that the directory has been copied to the second domain;
accessing the directory on the second domain.

2. The method of claim 1 wherein the copying occurs in response to a user accessing the second domain.

3. The method of claim 2 wherein the user accesses the second node by locally logging in to the second domain.

4. The method of claim 1 wherein copying the directory and creating the indication occurs in response to a directory migration request provided by a user.

5. The method of claim 1 wherein copying the directory and creating the indication occurs in response to an indication that the user is in proximity to the second domain.

6. The method of claim 5 wherein the indication that the user is in proximity to the second domain comprises the network detecting the user's proximity to the second domain via a wireless locator system, such as GPS.

7. The method of claim 1 wherein copying the directory and creating the indication occurs in response to an indication that the user will be in proximity to the second domain.

8. The method of claim 7 wherein the indication that the user will be in proximity to the second domain comprises the network determining that the user will be in proximity to the second domain from a schedule indicative of the user's movements.

9. The method of claim 1 wherein the method further comprises:
copying the directory from the second domain to the first domain;
deleting the indication that the directory has been copied to the second domain;
deleting the copy of the directory from the second domain;
accessing the directory on the first domain.

10. The method of claim 1 wherein the method further comprises:
copying the directory from the second domain to a third domain;
modifying the indication that the directory has been copied to the second domain to indicate that the directory has been copied to the third domain;
deleting the copy of the directory from the second domain;
accessing the directory on the third domain.

11. The method of claim 1 wherein the network is a wide area network.

12. The method of claim 1 wherein the directory is a home directory.

13. The method of claim 1 wherein the indication that the directory has been copied to the second domain is stored on the first domain.

14. The method of claim 13 wherein the indication that the directory has been copied to the second domain is stored in the directory being copied.

15. The method of claim 1 wherein the indication that the directory has been copied contains the network address of the second domain and the location of the copied directory on that domain.

16. The method of claim 1 wherein the copying of the directory includes compressing the directory and transferring a compressed form of the directory to the second domain.

17. The method of claim 1 wherein changes to the directory located on the first domain are prevented while accessing the directory on the second domain.

18. A computer network comprising:
a plurality of network domains, each domain further comprising one or more nodes;
a storage medium including instructions executable by one or more of the plurality of nodes to implement a method comprising:
accessing a stored directory in a first domain of said computer network;
copying the directory to a second domain of said computer network;
creating an indication that the directory has been copied to the second domain;
accessing the directory on the second domain.

19. The computer network of claim 18 wherein the user accesses the second node by locally logging in to the second domain.

20. The computer network of claim 18 wherein copying the directory and creating the indication occurs in response to a directory migration request provided by a user.

21. The computer network of claim 18 wherein copying the directory and creating the indication occurs in response to an indication that the user is in proximity to the second domain.

22. The computer network of claim 18 wherein copying the directory and creating the indication occurs in response to an indication that the user will be in proximity to the second domain.

23. The computer network of claim 18 wherein the method further comprises:
copying the directory from the second domain to the first domain;
deleting the indication that the directory has been copied to the second domain;
deleting the copy of the directory from the second domain;
accessing the directory on the first domain.

24. The computer network of claim 18 wherein the method further comprises:
copying the directory from the second domain to a third domain;
modifying the indication that the directory has been copied to the second domain to indicate that the directory has been copied to the third domain;
deleting the copy of the directory from the second domain;
accessing the directory on the third domain.

25. The computer network of claim 18 wherein the indication that the directory has been copied to the second domain is stored in the directory being copied.

26. The computer network of claim 18 wherein the indication that the directory has been copied contains the network address of the second domain and the location of the copied directory on that domain.

27. The computer network of claim 18 wherein the copying of the directory includes compressing the directory and transferring a compressed form of the directory to the second domain.

28. The computer network of claim 18 wherein changes to the directory located on the first domain are prevented while accessing the directory on the second domain.

29. A computer readable medium including program instructions executable to implement a method comprising:
accessing a stored directory in a first domain of said computer network;
copying the directory to a second domain of said computer network;
creating an indication that the directory has been copied to the second domain;
accessing the directory on the second domain.

30. The computer readable medium of claim 29 wherein the user accesses the second node by locally logging in to the second domain.

31. The computer readable medium of claim 29 wherein copying the directory and creating the indication occurs in response to a directory migration request provided by a user.

32. The computer readable medium of claim 29 wherein copying the directory and creating the indication occurs in response to an indication that the user is in proximity to the second domain.

33. The computer readable medium of claim 29 wherein copying the directory and creating the indication occurs in response to an indication that the user will be in proximity to the second domain.

34. The computer readable medium of claim 29 wherein the method further comprises:
copying the directory from the second domain to the first domain;
deleting the indication that the directory has been copied to the second domain;
deleting the copy of the directory from the second domain;
accessing the directory on the first domain.

35. The computer readable medium of claim 29 wherein the method further comprises:
copying the directory from the second domain to a third domain;
modifying the indication that the directory has been copied to the second domain to indicate that the directory has been copied to the third domain;
deleting the copy of the directory from the second domain;
accessing the directory on the third domain.

36. The computer readable medium of claim 29 wherein the indication that the directory has been copied to the second domain is stored in the directory being copied.

37. The computer readable medium of claim 29 wherein the indication that the directory has been copied contains the network address of the second domain and the location of the copied directory on that domain.

38. The computer readable medium of claim 29 wherein the copying of the directory includes compressing the directory and transferring a compressed form of the directory to the second domain.

39. The computer readable medium of claim 29 wherein changes to the directory located on the first domain are prevented while accessing the directory on the second domain.
